(19) United States
(12) Patent Application Publication
(10) Pub. No.: US 2025/0305838 A1
(43) Pub. Date: Oct. 2, 2025

(54) METHOD AND APPARATUS FOR DETERMINING TASK INFORMATION

(71) Applicant: Lenovo (Beijing) Limited, Beijing (CN)

(72) Inventors: Meizi LIN, Beijing (CN); Ruqing BAN, Beijing (CN); Lingyu LI, Beijing (CN)

(21) Appl. No.: 19/085,733

(22) Filed: Mar. 20, 2025

(30) Foreign Application Priority Data
Mar. 26, 2024 (CN) 202410354468.4

(51) Int. Cl. G01C 21/34

(52) U.S. Cl. CPC G01C 21/3415

(57) ABSTRACT

The disclosure describes a method and apparatus for determining task information. The method includes obtaining a first route, the first route corresponding to the moving trajectory of an acquisition device in the process of acquiring a first image set of a target space, the first image set being used to determine a target map corresponding to the target space; determining a second route based on the first route, the second route being at least partially identical to the first route; and determining a target task of a target device in the target space based on the second route and task point information.

### CROSS-REFERENCE TO RELATED APPLICATION

This application claims priority to Chinese Patent Application No. 202410354468.4, filed on Mar. 26, 2024, the content of which is incorporated herein by reference in its entirety.

### TECHNICAL FIELD

The present disclosure generally relates to the technical field of task determination, and in particular to a method and apparatus for determining task information.

### BACKGROUND

When executing a robot task, a user needs to edit the robot's movement path in advance, create task points for the robot, and clarify the coordinates of each task point on the map. After the robot task is generated, the user may issue the task to the robot to execute it. Simply put, the user needs to determine the robot's path and then add task points to obtain the task.

Regarding the determination of the robot path, there are generally two solutions in the existing technologies. The first solution is to use sensors to obtain the location data of obstacles in the robot's surrounding environment, build an obstacle location image based on the data, and generate the robot path through a path planning algorithm. The second solution is to manually edit the robot path on a pre-generated 2D map using editing tools.

It can be seen that for the first solution, path generation depends on sensors and path planning algorithms. Low sensor accuracy or weak algorithm optimization performance will affect the reliability of the path, and the route may be inaccurate or cause collisions. For the second solution, the efficiency is low, the labor cost is high, and the degree of automation is low.

### SUMMARY

The disclosure provides a method and apparatus for determining task information, which has the characteristics of high reliability, high efficiency and low cost. The technical solution of the disclosure is implemented as follows.

In one aspect, the disclosure provides a method for determining task information. The method includes obtaining a first route, where the first route corresponds to a moving trajectory of an acquisition device during a process of acquiring a first set of images of a target space, where the first set of images is used to determine a target map corresponding to the target space; determining a second route based on the first route, where the second route is at least partially identical to the first route; and determining a target task of a target device in the target space according to the second route and the task point information.

In another aspect, the disclosure provides a task information determination apparatus. The apparatus includes an acquisition unit, configured to obtain a first route, where the first route corresponds to a moving trajectory of an acquisition device during a process of acquiring a first set of images of a target space, where the first set of images is used to determine a target map corresponding to the target space; a first determination unit, configured to determine a second route according to the first route, where the second route is at least partially identical to the first route; and a second determination unit, configured to determine a target task of the target device in the target space according to the second route and task point information.

In another aspect, the disclosure further provides an electronic device, including: a memory and one or more processors. The memory stores a computer program executable by the one or more processors, and when executing the program, the one or more processors are configured to perform: obtaining a first route, where the first route corresponds to a moving trajectory of an acquisition device during a process of acquiring a first set of images of a target space, where the first set of images is used to determine a target map corresponding to the target space; determining a second route based on the first route, where the second route is at least partially identical to the first route; and determining a target task of a target device in the target space according to the second route and task point information.

In another aspect, the disclosure further provides a non-transitory computer-readable storage medium having a computer program stored thereon that, when being executed, causes at least one processor to perform a task information determination method as disclosed.

In another aspect, the disclosure also provides a computer program product, which includes a computer program, and when the computer program is executed by a processor, the task information determination method disclosed elsewhere herein is implemented.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solution in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a schematic structural diagram of an example scenario of a task information determination solution, according to some embodiments of the disclosure;

FIG. 2 is a flow chart of an example method for determining task information, according to some embodiments of the disclosure;

FIG. 3 is a flow chart of another example method for determining task information, according to some embodiments of the disclosure;

FIG. 4 is a flow chart of another example method for determining task information, according to some embodiments of the disclosure;

FIG. 5 is a flow chart of another example method for determining task information;

FIG. 6 is a flow chart of another example method for determining task information, according to some embodiments of the disclosure;

FIG. 7 is a flow chart of another example method for determining task information, according to some embodiments of the disclosure;

FIG. 8 is a flow chart of another example method for determining task information, according to some embodiments of the disclosure;

FIG. 9 is a flow chart of another example method for determining task information, according to some embodiments of the disclosure;

FIG. 10 is a schematic structural diagram of an example sub-route, according to some embodiments of the disclosure;

FIG. 11 is a flow chart of another example method for determining task information, according to some embodiments of the disclosure;

FIG. 12 is a schematic structural diagram of an example path for a real robot to perform a task, according to some embodiments of the disclosure;

FIG. 13 is a schematic structure diagram of an example scanning path, according to some embodiments of the disclosure;

FIG. 14 is a schematic structure diagram of an example unidirectional initial path, according to some embodiments of the disclosure;

FIG. 15 is a schematic structure diagram of an example bidirectional initial path, according to some embodiments of the disclosure;

FIG. 16 is a schematic structure diagram of an example path before and after clipping, according to some embodiments of the disclosure;

FIG. 17 is a schematic structure diagram of an example path after adding a task point, according to some embodiments of the disclosure;

FIG. 18 is a schematic structure diagram of an example path before and after modification, according to some embodiments of the disclosure;

FIG. 19 is a schematic structure diagram of an example complete path executed by a robot, according to some embodiments of the disclosure;

FIG. 20 is a schematic structure diagram of an example partial path executed by a robot, according to some embodiments of the disclosure;

FIG. 21 is a flow chart of an example task generation and execution process, according to some embodiments of the disclosure;

FIG. 22 is a schematic structure diagram of an example task information determination apparatus, according to some embodiments of the disclosure; and

FIG. 23 is a schematic structure diagram of an example electronic device, according to some embodiments of the disclosure.

### DETAILED DESCRIPTION

In order to make the purpose, technical solution and advantages of the embodiments of the disclosure clearer, the specific technical solution of the disclosure will be further described in detail hereinafter in conjunction with the drawings in the embodiments of the disclosure. The following embodiments are used to illustrate the disclosure, but are not used to limit the scope of the disclosure.

In the following description, reference is made to “some embodiments”, which describe a subset of all possible embodiments, but it will be understood that “some embodiments” may be the same subset or different subsets of all possible embodiments and may be combined with each other without conflict.

In the following description, the terms “first/second/third” are used merely as examples to distinguish different objects, but do not represent a specific order for the objects, nor do they have a limitation on the order of precedence. It is understandable that “first/second/third” may be interchanged with a specific order or order of precedence where permitted, so that the embodiments of the disclosure described herein may be implemented in an order other than that illustrated or described herein.

Unless otherwise defined, the technical and scientific terms used herein have the same meaning as those commonly understood by a person skilled in the art. The terms used herein are merely for the purpose of describing the embodiments of the disclosure and are not intended to limit the disclosure.

The embodiments of the disclosure may provide a task information determination method and apparatus, device and storage medium. In practical applications, the task information determination method may be implemented by a task information determination apparatus, and each functional entity in the task information determination apparatus may be collaboratively implemented by hardware resources of an electronic device, such as computing resource (e.g., a processor) and communication resource (e.g., for supporting various communication methods such as optical cables and cellular).

The disclosure does not limit the specific type of electronic device that performs the task information determination method, which may be determined according to actual needs. For example, the electronic device may be a server, a desktop computer, a notebook, a tablet computer, and the like.

To facilitate understanding, an example scenario of a task information determination solution provided by the embodiments of the disclosure is first described.

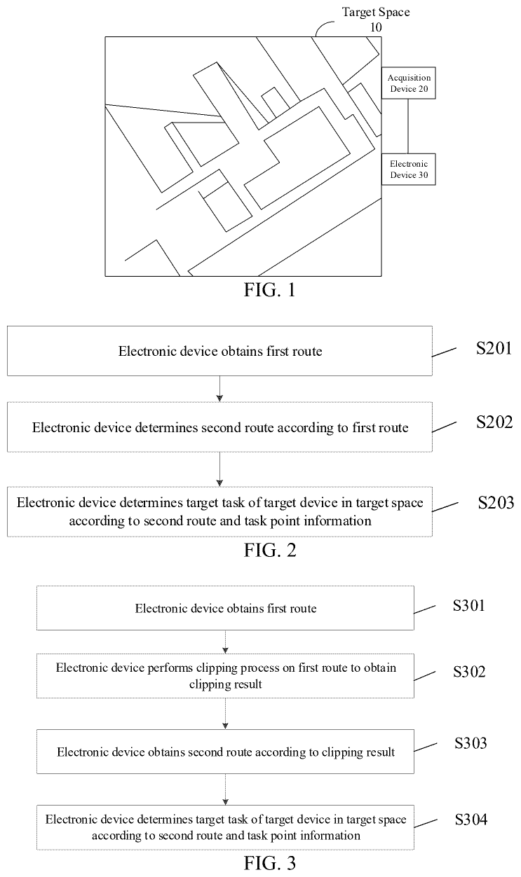

Exemplarily, referring to the content shown in FIG. 1, the scenario includes a target space 10, an acquisition device 20 and an electronic device 30.

The target space 10 is a space required for performing the target task. The embodiments of the disclosure do not specifically limit the target space 10. For example, the target space 10 may be an indoor space or an outdoor space.

The acquisition device 20 is a device with image acquisition capability, for example, a three-dimensional scanner or a camera.

The electronic device 30 is configured to: obtain a first route, where the first route corresponds to the movement trajectory of the acquisition device during the process of acquiring a first image set of a target space, and the first image set is used to determine a target map corresponding to the target space; determine a second route based on the first route, where the second route is at least partially identical to the first route; and determine a target task of the target device in the target space based on the second route and task point information.

The electronic device 30 is a device with relevant data processing capabilities. Exemplarily, the electronic device 30 may be a computer, a server, and the like.

Various embodiments of the task information determination method, apparatus, device, and storage medium provided in the embodiments of the disclosure will be described hereinafter.

In one aspect, the embodiments of the disclosure provide a method for determining task information. The task information determination process provided by the embodiments of the disclosure is described by using the electronic device as the execution entity. Referring to the content shown in FIG. 2, the task information determination method may include but is not limited to S201 to S203 shown in FIG. 2.

S201: The electronic device obtains a first route.

The first route corresponds to a moving trajectory of the acquisition device during the process of acquiring the first image set of the target space.

The first image set is used to determine a target map corresponding to the target space.

The target space refers to the space that the target device needs to pass through to perform the target task.

The target device, target task and target space in the embodiments of the disclosure are not specifically limited and may be configured according to actual needs.

For example, the target device may be a robot or a mobile intelligent device. The target task may be an inspection task or a search task, etc. The target space may be an indoor scene such as a substation or an outdoor scene such as a street.

At first, the acquisition device needs to acquire a first image set of the target space, and determine a target map corresponding to the target space based on the first image set.

In order to obtain the target map corresponding to the target space, the whole target space needs to be collected. Accordingly, the movement trajectory of the acquisition device may be spread over various locations in the target space. The movement trajectory is thus relatively comprehensive. In addition, if the acquisition device is moved manually, obstacles may be avoided. Therefore, the trajectory is comprehensive and reliable. Accordingly, in the disclosed embodiments, the movement trajectory of the acquisition device during the acquisition process of the first image set is directly recorded, and the first route is directly obtained based on the movement trajectory.

The process of obtaining the first route here may be performed by the acquisition device, and then the acquisition device transmits the first route to the electronic device. Alternatively, the acquisition device sends the acquired movement trajectory to the electronic device, and the electronic device determines the first route based on the movement trajectory.

S202: The electronic device determines a second route according to the first route.

The second route is at least partially identical to the first route.

In some embodiments, the electronic device directly determines the first route to be the second route.

In some embodiments, the electronic device performs a first processing on the first route to obtain the second route.

The embodiments of the disclosure do not limit the content of the first processing, which may be configured according to actual needs. For example, the first processing may include but is not limited to one or more of the following: clipping, direction adjustment, straight line adjustment, determining a starting point, determining an end point, etc.

S203: The electronic device determines the target task of the target device in the target space according to the second route and task point information.

The task point information may include but is not limited to the location of a task point and the task content of the task point. The task point location refers to the corresponding location of a task point in the target space, and the task content of the task point represents a task that the target device needs to perform at the task point.

The target task is the information required for the target device to perform the task. After the target device obtains the target task, the target device determines the travel route and task point(s) in the target space based on the information in the target task, and performs the task according to the information in the target task.

The embodiments of the disclosure do not limit the number of pieces of task point information, which may be configured according to actual needs. The task point information here may be the task point information of one task point, or the task point information of multiple task points.

Exemplarily, the task point information may include task point information of task point 1 and task point information of task point 2. The task information of task point 1 includes: location 1, check whether the switch is closed; and the task information of task point 2 includes: location 2, detect whether the temperature exceeds the temperature threshold.

S203 may be implemented as follows: the electronic device sequentially adds one or more tasks in the second route based on one or more pieces of task point information in the second route, thereby obtaining the target task.

The method of the task information determination solution provided by the embodiments of the disclosure at least includes: obtaining a first route, where the first route corresponds to the movement trajectory of an acquisition device in the process of acquiring a first image set for a target space, and the first image set is used to determine a target map corresponding to the target space; determining a second route based on the first route, where the second route is at least partially identical to the first route; and determining a target task of a target device in the target space based on the second route and task point information.

In the disclosed embodiments, when determining the target task, the target task is obtained based on the second route and the task point information, and the second route is determined based on the first path, and the first route corresponds to the moving trajectory of the acquisition device in the process of acquiring the first image set of the target space. It can be seen that, firstly, the disclosure directly determines the first route based on the moving trajectory when acquiring the first image set by the acquisition device. Since the moving trajectory generally bypasses obstacles, the reliability of the obtained first route is relatively high. Secondly, since the moving trajectory in the acquisition process is directly reused as the first route, no additional device or manpower is required, so the cost is relatively low. Thirdly, since the moving trajectory in the acquisition process is directly reused as the first route, the second route is determined based on the first route, and the target task may be directly obtained based on the second route and the task point information without manual operation or sensor acquisition, the efficiency is also relatively high.

In some embodiments, the target space includes a target object, where the target object may hinder the target device from moving in the target space.

In practice, the target space may include one or more target objects or may not include any target object.

When there is a target object in the target space, since the moving trajectory of the acquisition device generally avoids obstacles, that is, avoids the target object, the first route obtained based on the moving trajectory may avoid the target object, thereby reducing the possibility of collision and having higher reliability.

Next, the process of the electronic device determining the second route according to the first route in S202 is described. The process may include but is not limited to the following Methods 1 to 4, and combinations of various forms of Methods 1 to 4.

Method 1: Clip the first route.

Method 2: Adjust the direction of part of the first route.

Method 3: Adjust some sub-routes in the first route to straight lines.

Method 4: Determine, from the first route, a starting point of the second route based on a charging point.

Next, the task information determination process is described by taking the process of clipping the first route in Method 1 as an example.

With reference to the content shown in FIG. 3, the process may include but is not limited to the following S301 to S304.

S301: The electronic device obtains a first route.

The implementation of S301 may refer to the detailed description of S201 above, which will not be described in detail here.

S302: The electronic device performs a clipping process on the first route to obtain a clipping result.

The first route may be clipped based on a received clipping instruction or automatically clipped based on information corresponding to the target point(s).

S303: The electronic device obtains the second route according to the clipping result.

In some embodiments, the electronic device directly uses the clipping result as the second route.

In some embodiments, the electronic device performs a second process on the clipping result to obtain a second route. The second process may include but is not limited to one or more of the following: direction adjustment, line adjustment, determining the starting point, determining the end point, and the like.

S304: The electronic device determines the target task of the target device in the target space according to the second route and task point information.

The implementation of S304 may refer to the detailed description of S203 above, which will not be described in detail here.

By clipping the first route, redundant routes in the first route may be removed, thereby improving the execution efficiency of the target task.

Next, the process of the electronic device performing a clipping process on the first route to obtain the clipping result in S302 is further described.

The process may include but is not limited to implementation A or implementation B described below.

Implementation A: Perform a clipping process based on the information corresponding to the target point(s).

Implementation B: Perform a clipping process based on a clipping instruction.

Next, the process of performing a clipping process based on the information corresponding to the target point(s) in implementation A is processed.

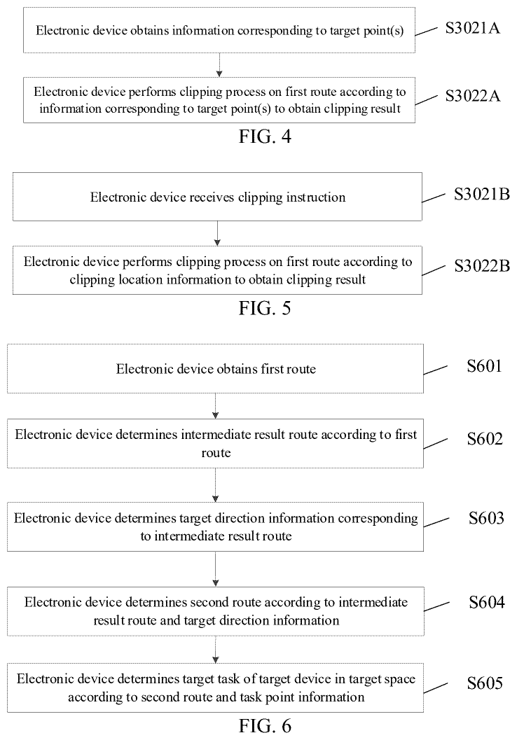

With reference to the content shown in FIG. 4, the process may include but is not limited to the following S3021A and S3022A.

S3021A: The electronic device obtains information corresponding to the target point(s).

The target point(s) includes at least one of the following: a task point and a waypoint, where the waypoint represents a point where the motion state of the target device changes.

The change in motion state here may include: a change in motion direction, or a change in floor level.

For example, generally, if the direction of movement needs to be changed, a waypoint may be added as a sign at the change location. If it is necessary to go upstairs or downstairs, a waypoint may be added as a sign at the upstairs or downstairs location.

A task point refers to a location where a task is performed.

The disclosure does not limit the number of task points and waypoints, which may be configured according to actual needs.

The information corresponding to a target point includes the location information of the target point.

S3021A may be implemented as follows: the electronic device receives a task instruction, and obtains information corresponding to the target point(s) based on the information of the task instruction.

S3022A: The electronic device performs a clipping process on the first route according to the information corresponding to the target point(s) to obtain the clipping result.

The electronic device cuts out redundant routes on the first route that are irrelevant to the information corresponding to the target point(s).

In this way, the clipping process is automatically performed based on the information corresponding to the target point(s), which is simple and efficient to implement.

Next, the process of performing a clipping process based on the clipping instruction in implementation B is described.

With reference to the content shown in FIG. 5, the process may include but is not limited to the following S3021B and S3022B.

S3021B: The electronic device receives a clipping instruction.

The clipping instruction includes clipping location information.

The clipping location information here may be continuous location information, for example, location A1 to location A2; or may be a plurality of pieces of continuous location information, for example, location A1 to location A2, and location A3 to location A4.

S3022B: The electronic device performs a clipping process on the first route according to the clipping location information to obtain the clipping result.

The electronic device cuts off the route(s) pointed to by the clipping location(s) in the first route to obtain the clipping result.

It can be seen that clipping based on the clipping instruction has the characteristics of flexible implementation and high reliability.

Next, the process of determining the task information is described by taking Method 2 of adjusting the direction of a part of the first route as an example.

With reference to the content shown in FIG. 6, the process may include but is not limited to the following S601 to S605.

S601: The electronic device obtains a first route.

The implementation of S601 may refer to the detailed description of S201 above, which will not be repeated here.

S602: The electronic device determines an intermediate result route according to the first route.

In some embodiments, the electronic device determines a direction in the first route as the direction in the intermediate result route, that is, if the direction of the first part in the first route is to the left, then the direction of the first part in the intermediate result route is to the left.

For example, the intermediate result route includes original direction information, and the original direction information represents the direction of travel of the acquisition device during the process of acquiring the first image set of the target space, that is, the direction in the first route.

In some embodiments, the electronic device determines all directions in the intermediate result routes as bidirectional, that is, if the direction of the first part in the first route is left, then the direction of the first part in the intermediate result route is left or right.

For example, the intermediate result route includes intermediate direction information, and the intermediate direction information is bidirectional.

In practice, if the direction of the intermediate result route is consistent with the direction of the first route, it has the benefits of simple implementation. For a route, if it is possible to go from left to right, then the route from right to left is also possible, so the direction of the intermediate result route may also be determined as bidirectional, which may be applied to more tasks, so it has the benefits of wide applications.

S603: The electronic device determines target direction information corresponding to the intermediate result route.

The target direction information matches the target task.

The electronic device determines the target direction information of an intermediate result route according to the execution order of the tasks.

For example, the target tasks include Task 1, Task 2, and Task 3. Task 1 is at location 1, Task 2 is at location 2, and Task 3 is at location 3. The execution order of the three tasks is Task 1, Task 2, and Task 3. Then the target direction information is determined to include: the direction between location 1 and location 2, and the direction from location 2 to location 3.

S604: The electronic device determines the second route according to the intermediate result route and the target direction information.

In some embodiments, the electronic device updates the direction in the intermediate result route based on the target direction information to obtain the second route.

In some embodiments, the electronic device updates the direction in the intermediate result route based on the target direction information, and obtains the second route after performing other processing. The other processing here may include but is not limited to at least one of the following: line adjustment, determining a starting point, determining an end point, etc.

S605: The electronic device determines the target task of the target device in the target space according to the second route and task point information.

The implementation of S605 may refer to the detailed description in the above S203, which will not be described in detail here.

In this way, in the process of obtaining the second route from the first route, the direction of the route is adjusted, which may be more suitable for the execution of the task and improve the efficiency of the execution of the target task.

The following is an explanation of the process in which the electronic device determines the target direction information corresponding to the intermediate result route in S603.

This process may include but is not limited to the following Case A or Case B.

Case A: Determine the target direction information based on the information corresponding to the task point(s).

Case B: Determine the target direction information based on the direction adjustment instruction.

Next, the process of determining the target direction information based on the information corresponding to the task point(s) in situation A is described.

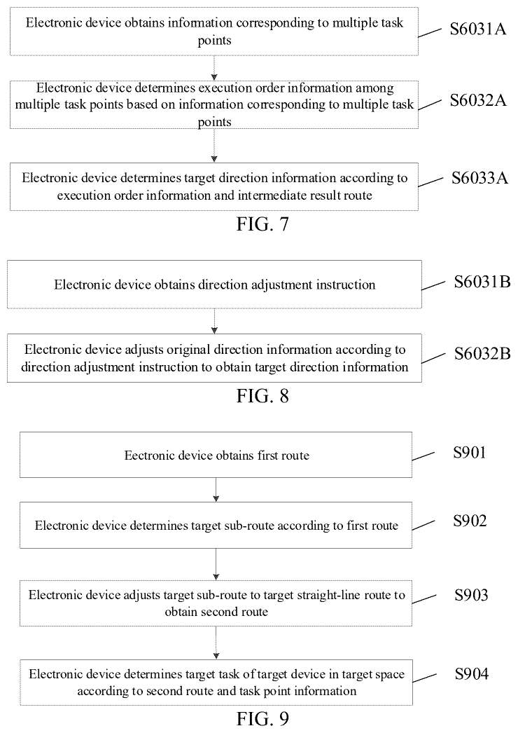

Referring to the content shown in FIG. 7, the process may include but is not limited to the following S6031A to S6033A.

S6031A: The electronic device obtains information corresponding to multiple task points.

The information corresponding to the task points includes at least the location of the task points. The information corresponding to the task points may also include: the name of the task points, the task order, the task priorities, etc.

The electronic device receives multiple operations and obtains information corresponding to multiple task points based on the operations.

S6032A: The electronic device determines the execution order information among the multiple task points based on the information corresponding to the multiple task points.

If the information corresponding to the multiple task points includes the task order, the execution order among the multiple tasks is determined.

If the information corresponding to the multiple task points does not include the task order but includes the locations of the task points, the execution order of the multiple tasks is determined based on the locations of the task points.

If the information corresponding to the multiple task points does not include the task order, but includes the locations of the task points and the task priorities, the execution order among the multiple tasks is determined based on the locations of the task points and the task priorities, where the location of a task point with a higher task priority is arranged earlier.

S6033A. The electronic device determines the target direction information according to the execution order information and the intermediate result route.

The electronic device sequentially adds the target direction information to the intermediate result routes in accordance with the execution order.

In this way, the target direction information is determined based on the execution order information between multiple task points, which may meet the actual task requirements, and has high flexibility and a wide range of applications.

Next, the process of determining the target direction information based on the direction adjustment instruction in situation B is described.

Referring to the content shown in FIG. 8, the process may include but is not limited to the following S6031B and S6032B.

S6031B: The electronic device obtains a direction adjustment instruction.

The electronic device receives an operation from a user and obtains a direction adjustment instruction based on the operation.

S6032B: The electronic device adjusts the original direction information according to the direction adjustment instruction to obtain the target direction information.

The electronic device analyzes the direction indicated by the direction adjustment instruction, adjusts the original direction information to the direction indicated by the adjustment instruction, and obtains the target direction information.

The embodiments of the disclosure do not limit the amount of the target direction information to be adjusted in the first route, which may be determined according to actual needs. Here, the directions of one or more parts of the first route may be adjusted.

Adjusting the target direction based on the direction adjustment instruction may meet the actual needs of the user and has the characteristic of strong adaptability.

Next, the process of determining the task information is described by taking Method 3 of adjusting part of the first route to a straight line as an example.

Referring to the content shown in FIG. 9, the process may include but is not limited to S901 to S904.

S901: The electronic device obtains a first route.

The implementation of S901 may refer to the detailed description of S201 above, which will not be described in detail here.

S902: The electronic device determines a target sub-route according to the first route.

The target sub-route is a portion of the first route.

There is no specific limitation on the number of target sub-routes, and the target sub-route may be one or more.

S903: The electronic device adjusts the target sub-route to a target straight-line route to obtain a second route.

The embodiments of the disclosure do not limit the specific method of adjusting the target sub-route to a target straight-line route, and may be configured according to actual needs. For example, the target sub-route may be adjusted to the target straight-line route based on the starting point and the end point of the target straight-line route. Alternatively, the target sub-route may also be adjusted to the target straight-line route based on the turning point in the target straight-line route.

S904: The electronic device determines the target task of the target device in the target space according to the second route and task point information.

The implementation of S904 may refer to the detailed description in the above S203, which will not be described in detail here.

In practice, since the first route corresponds to the trajectory of the acquisition device, the acquisition device may make multiple adjustments near a location in order to acquire a comprehensive view during the image acquisition process. Therefore, the first route directly obtained based on the trajectory may have multiple bending points in a sub-route. In this process, a target sub-route with multiple bending points may be adjusted to a target straight-line route. In this way, the obtained second route is more conducive to the movement of the target device.

Next, the process of the electronic device determining a target sub-route according to the first route in S902 is described.

In some embodiments, the electronic device determines a target sub-route according to the moving range of each part of the first route.

The target straight-line route is a straight-line route along a first direction, the moving range of the target sub-route in a second direction is smaller than a target threshold, and the first direction is different from the second direction.

The embodiments of the disclosure do not limit the value of the target threshold, which may be determined according to actual needs.

The second direction here may be perpendicular to the first direction, or have a certain angle with the first direction.

In some embodiments, the electronic device receives an adjustment instruction, where the adjustment instruction includes adjustment location information, and determines the target sub-route from the first route information according to the adjustment location information.

The adjustment instruction here is used to indicate that a sub-route is a target sub-route and needs to be adjusted to a straight line.

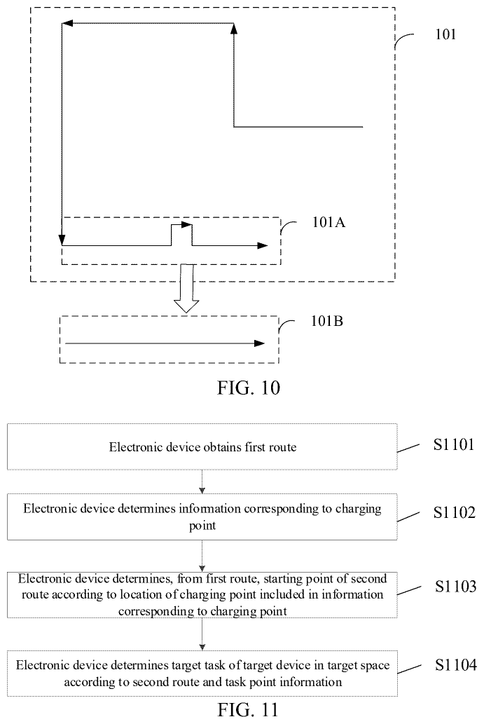

For example, referring to the content shown in FIG. 10, in FIG. 10, the first route is 101, the target sub-route is 101A, and the corresponding adjusted target straight-line route is 101B.

It can be seen that in the disclosed embodiment, the target sub-route may be automatically determined by the moving range of each part of the first route, or the target sub-route may be determined by the adjustment location information in the adjustment instruction. In practice, the two methods may be selected according to actual needs, which is flexible and widely used, and has a good user experience.

Next, determining, from the first route, the location of the starting point of the second route based on the charging point in Method 4 is taken as an example to illustrate the process of determining the task information.

The first route starts from a charging point in the target space, where the charging point corresponds to a charging device that charges the target device.

In other words, the starting point of the first route is the location of the charging device. In this way, each time the target device executes a target task, it starts from the charging device, so that the target device has sufficient power to provide energy for the execution of the target task, thereby improving the reliability of the target task execution process.

Referring to the content shown in FIG. 11, the process may include but is not limited to S1101 to S1104.

S1101: The electronic device obtains a first route.

The implementation of S1101 may refer to the detailed description of S201 above, which will not be described in detail here.

S1102: The electronic device determines information corresponding to a charging point.

A charging point is in the target space, and the charging point corresponds to a charging device that charges the target device.

The information corresponding to a charging point may include: the location of the charging point.

The information corresponding to a charging point may also include: the serial number and name of the charging point, etc.

The electronic device may be pre-configured with information corresponding to the charging point, where the electronic device directly determines the information corresponding to the charging point associated with the target device.

S1103: The electronic device determines, from the first route, the starting point of the second route according to the location of a charging point included in the information corresponding to the charging point.

It should be noted that, in practice, the end point of the second route may also be determined. The specific location of the end point is not limited here and may be configured according to actual needs.

S1104: The electronic device determines the target task of the target device in the target space according to the second route and task point information.

The implementation of S1104 may refer to the detailed description in the above S203, which will not be described in detail here.

Exemplarily, the end point may be determined to be a charging point. In this way, the target device directly returns to a charging point for charging after completing the target task, so that it may be used directly next time, thereby improving convenience.

It should be noted that, in practice, the processing in Methods 1 to 4 may also be combined to obtain the second route.

Example 1: When obtaining the second route according to the first route, Method 1 may be combined with Method 2. That is, the first route is firstly clipped, and then the direction of a part of the first route is adjusted to obtain the second route.

Example 2: When obtaining the second route according to the first route, Method 1 may be combined with Method 3. That is, the first route is firstly clipped, and then part of the sub-routes in the first route are adjusted to straight lines, so as to obtain the second route.

Example 3: When obtaining the second route according to the first route, Method 1 may be combined with Method 4. That is, the first route is firstly clipped, and then the starting point of the second route is determined from the first route, so as to obtain the second route.

Example 4: When obtaining the second route according to the first route, Method 2 may be combined with Method 3. That is, the direction of a part of the first route is first adjusted, and then part of the sub-routes in the first route are adjusted to straight lines, so as to obtain the second route.

Example 5: When obtaining the second route according to the first route, Method 2 may be combined with Method 4. That is, the direction of a part of the first route is first adjusted, and then the starting point of the second route is determined from the first route, so as to obtain the second route.

Example 6: When obtaining the second route according to the first route, Method 3 may be combined with Method 4. That is, firstly part of the sub-routes in the first route are adjusted to straight lines, and then the starting point of the second route is determined from the first route, so as to obtain the second route.

Example 7: When obtaining the second route according to the first route, Method 1, Method 2 and Method 3 may be combined. That is, the first route is firstly clipped, and then the direction of a part of the first route is adjusted, and then part of the sub-routes in the first route are adjusted to straight lines, so as to obtain the second route.

Example 8: When obtaining the second route according to the first route, Method 1, Method 2 and Method 4 may be combined. That is, the first route is firstly clipped, and then the direction of a part of the first route is adjusted, and then the starting point of the second route is determined from the first route based on the charging point, so as to obtain the second route.

Example 9: When obtaining the second route according to the first route, Method 2, Method 3 and Method 4 may be combined. That is, firstly the direction of a part of the first route is adjusted, then part of the sub-routes in the first route are adjusted to straight lines, and then the starting point of the second route is determined from the first route based on the charging point, so as to obtain the second route.

Example 10: When obtaining the second route according to the first route, Method 1, Method 2, Method 3 and Method 4 may be combined. That is, the first route is firstly clipped, and then the direction of a part of the first route is adjusted, and then part of the sub-routes in the first route are adjusted to straight lines, and then the starting point of the second route is determined from the first route based on the charging point, so as to obtain the second route.

It is to be noted that the process of the electronic device determining the second route according to the first route in S202 may also include other processing methods, which are not listed here one by one. In some embodiments, these other processing methods may also be combined with the above-described Methods 1 to 4.

In practice, the execution order of each method when combined may be configured based on actual needs, which will not be listed here one by one.

Hereinafter, the task information determination method provided in the embodiments of the disclosure will be described by taking a robot task in a digital twin scenario as an example.

When executing a robot (equivalent to the target device described earlier) task in a digital twin scenario, it is necessary to edit the robot's movement path in advance. That is, after creating task points for the robot twin, clarify the coordinates (location data) of each task point on the map, and manually or automatically connect each coordinate on the two-dimensional map to generate a path for the real robot to perform the task. Only then may the task be issued to the real robot in the platform.

The operation of this process is too long and not user-friendly; and the steps for editing the path require a certain learning cost, which reduces the efficiency of the digital twin platform. Especially when the robot path involves crossing floors, a user needs to configure the points and directions of going up and down the stairs, which increases the complexity of use.

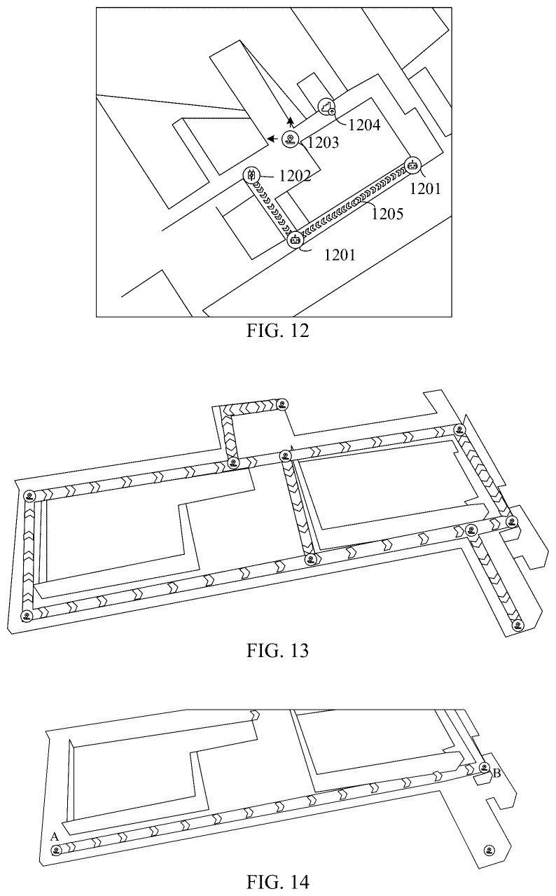

Referring to the content shown in FIG. 12, when generating a path for a real robot to perform a task, it is necessary to add a task point 1201, a charging point 1202, a waypoint 1203, entrance stairs 1204, and a route 1205. The task is generated for the real robot to perform the task through the task point 1201, the charging point 1202, the waypoint 1203, the entrance stairs 1204, and the route 1205.

A solution in Existing Technology 1 includes: using sensors to obtain the location data of obstacles in the robot's surrounding environment, constructing an obstacle location image based on the data, and generating a path based on the location image through a path planning algorithm. After the path is generated, check whether there are any free points (task points that are not planned). If there are any, manually plan the free points in the path.

Existing Technology 1 has the following disadvantages: 1. Path generation relies on the location data obtained by the sensor and the path planning algorithm. Low sensor accuracy or weak algorithm optimization performance will affect the final path generation, resulting in inaccurate routes for real robots and collisions. 2. Replanning free points to the path requires manual operation, which is prone to errors and not smart enough. 3. For complex paths, such as running between multiple floors or running back and forth between two points, this solution may not generate ideal results.

Another solution in Existing Technology 2 includes: manually connecting each task point on a pre-generated 2D map through a road network editing tool. Since the connecting lines are all straight lines, when encountering obstacles that cannot be passed, the direction/turning point of the robot path is changed by adding waypoints.

Existing Technology 2 has the following disadvantages: 1. If there are too many points in a task, task points will be missed when connecting the lines, resulting in free points. Before issuing the task, the platform needs to make an additional judgment on whether there are free points. 2. The path generation method is too dependent on manual work, which is prone to problems such as incorrect point order and missing points.

In response to the above problems and defects, the solution of the disclosed embodiment includes: using a three-dimensional scanner, when the operator scans the environment map of the robot to perform the task, the operator's scanning path is recorded. After the scanning is completed, the map and the scanning path are generated at the same time, and the path is the route for the robot to perform the task. After the robot task points are created, the task points are placed on the route in the execution order, and a robot task (equivalent to the above target task) may be generated.

The disclosed embodiments have the following technical effects: 1. The path editing steps are reduced when creating a task. After configuring the task points on the map, the task may be issued, shortening the operation path. 2. The operator will automatically avoid obstacles (equivalent to the above-described target objects) during scanning, so the path must be better than the result calculated by the sensor and algorithm, and the robot will not collide if it runs along this path. 3. Before creating a task using this method, a user only needs to create the task point(s). There is no need to configure the waypoints or the locations and directions of the stairs, which reduces the complexity of use.

The disclosed embodiments may specifically include but are not limited to the following Steps 1 to 6.

Step 1: Use a 3D scanner (equivalent to the above acquisition device) to obtain the environment map (equivalent to the above target map) of the robot performing the task and record the walking route (equivalent to the above moving trajectory) during acquisition.

Step 2: Generate three-dimensional data of the environment map (equivalent to the above first image set) and a scanning path (equivalent to the first route described earlier).

The generated scanning path may refer to the content shown in FIG. 13.

1) If the scanning route is unidirectional (such as scanning from point A to point B in FIG. 14), the generated initial path (equivalent to the original direction described earlier) is also unidirectional.

The unidirectional initial path may refer to the content shown in FIG. 14. For example, in FIG. 14, the direction from point A to point B is unidirectional AB.

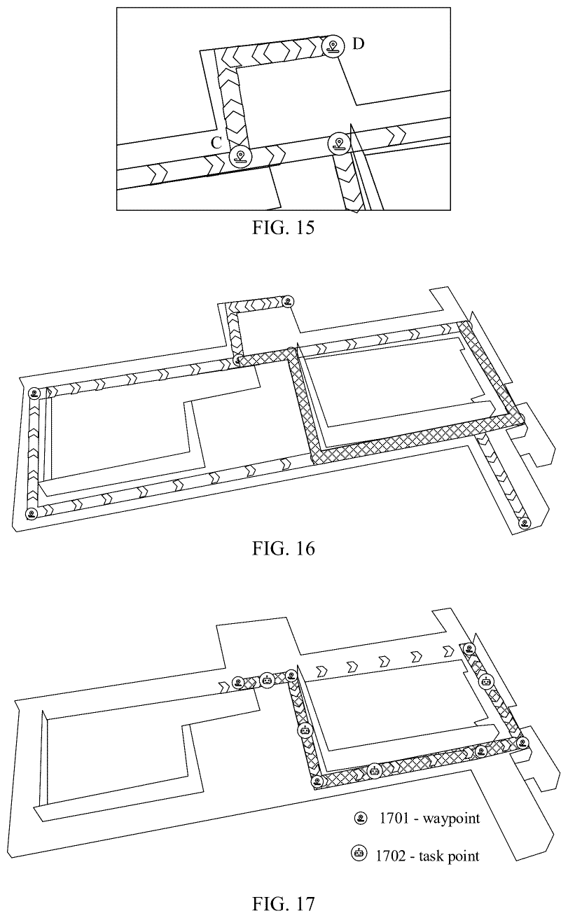

2) If the route during scanning is bidirectional (such as from point C to point D and then back to point C in FIG. 15), the generated initial path is bidirectional.

The bidirectional initial path may refer to the content shown in FIG. 15. For example, in FIG. 15, the direction from point C to point D is bidirectional CD and DC.

Step 3: Clip the path to obtain a path required for the robot task (equivalent to the above clipping result).

Referring to the content shown in FIG. 16, the path before clipping is the white path (without cross) in FIG. 16, and the path after clipping is the shadow path (with crosses) in FIG. 16.

Step 4: Create N task points of the robot on the clipped path, and drag each task point to a location to be executed on the 3D map in turn, so that the task point coincides with the scanning path.

The path after adding the task points may refer to the content shown in FIG. 17. In FIG. 17, 1701 is the waypoint and 1702 is the task point.

Step 5: Based on the directional (uni-/bi-directional) path generated in Step 2, the path direction may be modified.

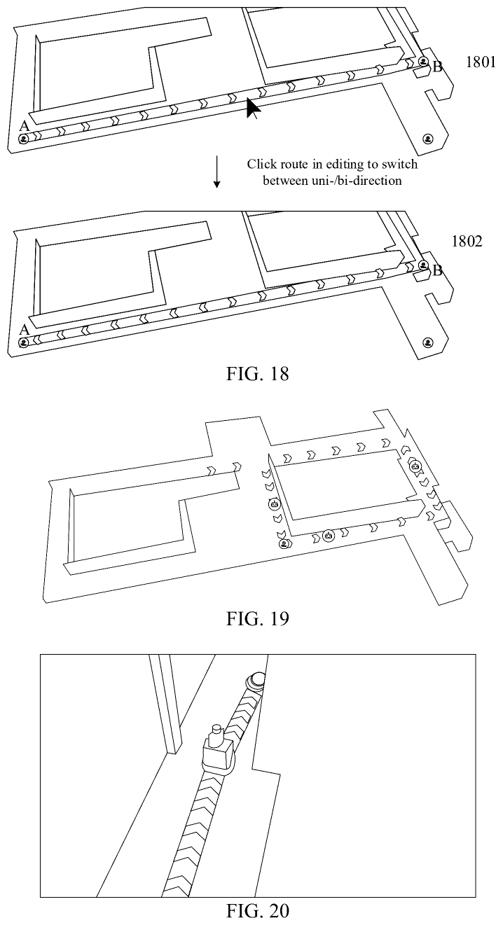

The paths before and after modification refer to the content shown in FIG. 18. The initial path is a unidirectional line segment from left to right (as shown by 1801 in FIG. 18), which may be modified to a unidirectional line segment from right to left or a bidirectional line segment (as shown by 1802 in FIG. 18). Since the scanning path has directionality, the locations of the task points on the path correspond to the execution order of the task points.

Step 6: Complete the editing of task points and path, generate the task (equivalent to the target task described earlier), and the robot executes these tasks in a coordinated manner in the corresponding scenario.

The complete path executed by the robot may refer to the content shown in FIG. 19, and the partial path executed by the robot may refer to the content shown in FIG. 20.

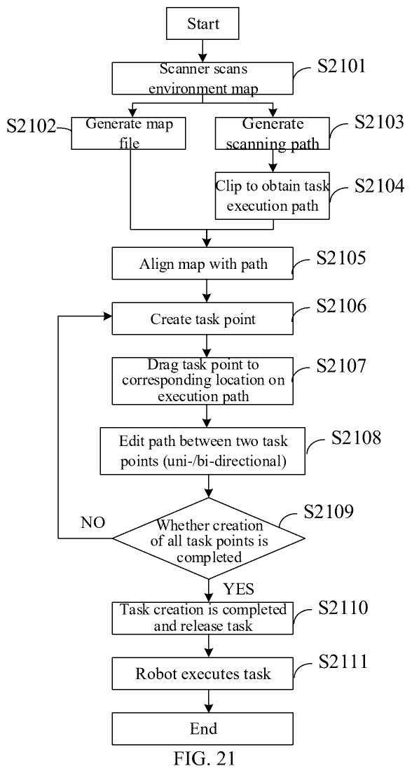

In brief, the task generation and execution process may refer to the content shown in FIG. 21, and the process may include S2101 to S2111.
Start.
S2101: A scanner scans an environment map.
S2102: Generate a map file.
S2103: Generate a scanning path.
S2104: Clip to obtain a task execution path.
S2105: Align the map with the path.
S2106: Create a task point.
S2107: Drag the task point to the corresponding location on the execution path.
S2108: Edit the path between two task points (uni-/bi-directional).
S2109: Whether the creation of all task points is completed.
If yes, proceed to S2110. If no, return to execute the above S2106.
S2110: The task creation is completed. Release the task.
S2111: The robot performs the task.
End.

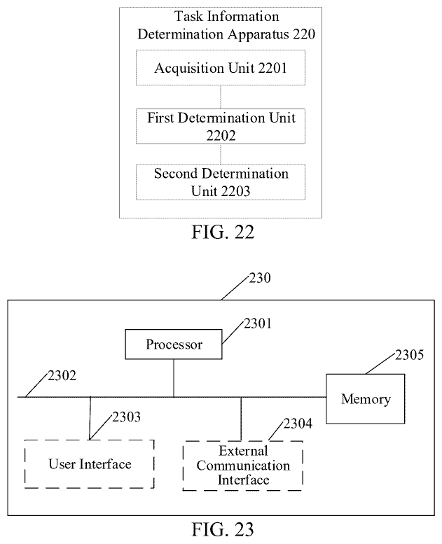

In another aspect, in order to implement the task information determination method described above, a task information determination apparatus according to some embodiments of the disclosure is described hereinafter in conjunction with the structural schematic diagram of the task information determination apparatus shown in FIG. 22.

As shown in FIG. 22, the task information determination apparatus 220 includes an acquisition unit 2201, a first determination unit 2202, and a second determination unit 2203.

The acquisition unit 2201 is configured to obtain a first route, where the first route corresponds to a moving trajectory of an acquisition device during a process of acquiring a first image set for a target space, where the first image set is used to determine a target map corresponding to the target space.

The first determination unit 2202 is configured to determine a second route according to the first route, where the second route is at least partially identical to the first route.

The second determination unit 2203 is configured to determine a target task of a target device in the target space according to the second route and task point information.

In some embodiments, the target space includes a target object, where the target object may hinder the target device from moving in the target space.

In some embodiments, the first determination unit 2202 is further configured to: perform a clipping process on the first route to obtain a clipping result, and obtain the second route according to the clipping result.

In some embodiments, the first determination unit 2202 is further configured to: obtain information corresponding to a target point, the target point including at least one of a task point and a waypoint, where the waypoint represents a point where the motion state of the target device changes; and perform the clipping process on the first route according to the information corresponding to the target point to obtain the clipping result.

In some embodiments, the first determination unit 2202 is further configured to: receive a clipping instruction, where the clipping instruction includes clipping location information; and clip the first route according to the clipping location information to obtain the clipping result.

In some embodiments, the first determination unit 2202 is further configured to: determine an intermediate result route based on the first route; determine target direction information corresponding to the intermediate result route, where the target direction information matches the target task; and determine the second route based on the intermediate result route and the target direction information.

In some embodiments, the first determination unit 2202 is further configured to: obtain information corresponding to multiple task points; determine the execution order information among the multiple task points based on the information corresponding to the multiple task points; and determine the target direction information based on the execution order information and the intermediate result route.

In some embodiments, the intermediate result route includes original direction information, and the original direction information represents the direction of travel of the acquisition device during the process of acquiring the first image set of the target space. The first determination unit 2202 is further configured to: obtain a direction adjustment instruction, and adjust the original direction information according to the direction adjustment instruction to obtain the target direction information.

In some embodiments, the first determination unit 2202 is further configured to: determine a target sub-route according to the first route, the target sub-route being a portion of the first route; and adjust the target sub-route to a target straight-line route.

In some embodiments, the first determination unit 2202 is further configured to: determine the target sub-route according to the moving range of each part of the first route, where the target straight-line route is a straight route along the first direction, the moving range of the target sub-route in the second direction is less than a target threshold, and the first direction is different from the second direction.

In some embodiments, the first determination unit 2202 is further configured to: receive an adjustment instruction, where the adjustment instruction includes adjustment location information; and determine the target sub-route from the first route according to the adjustment location information.

In some embodiments, the first route starts from a charging point in the target space, where the charging point corresponds to a charging device that charges the target device.

In some embodiments, the first determination unit 2202 is further configured to: determine information corresponding to a charging point, where the charging point is in the target space, and the charging point corresponds to a charging device that charges the target device; and determine, from the first route, the starting point of the second route based on the information corresponding to the charging point.

It should be noted that a task information determination apparatus provided in the embodiments of the disclosure includes the various units, which may be implemented by a processor in an electronic device. Apparently, the task information determination apparatus may also be implemented by a specific logic circuit. In the implementation process, the processor may be a central processing unit (CPU), a microprocessor unit (MPU), a digital signal processor (DSP) or a field programmable gate array (FPGA), etc.

The description of the apparatus embodiments is similar to the description of the above method embodiments, and has similar beneficial effects as the method embodiments. For technical details not disclosed in the apparatus embodiments of the disclosure, refer to the description of the method embodiments of the disclosure for understanding.

It should be noted that in the embodiments of the disclosure, if the above-described task information determination methods are implemented in the form of software function modules and sold or used as an independent product, these modules may also be stored in a computer-readable storage medium. Based on this understanding, the technical solution of the embodiments of the disclosure may be essentially or partly reflected in the form of a software product that contributes to the relevant technology. The computer software product is stored in a storage medium, including specific instructions to enable a computer device (which may be a personal computer, a server, or a network device, etc.) to execute all or part of the methods described in each embodiment of the disclosure. The storage medium includes various media that may store program codes, such as a USB flash drive, a mobile hard disk, a read-only memory (ROM), a disk or an optical disk. In this way, the embodiments of the disclosure are not limited to any specific combination of hardware and software.

In another aspect, in order to implement the task information determination methods described above, embodiments of the disclosure provide an electronic device, including a memory and a processor, where the memory stores a computer program that may be run on the processor, and when the processor executes the program, the computer program implements the steps in the task information determination methods provided in the above-described embodiments.

The structure diagram of the electronic device is described below with reference to the electronic device 230 shown in FIG. 23.

In some embodiments, the electronic device 230 may be the electronic device described above. As shown in FIG. 23, the electronic device 230 includes: a processor 2301, at least one communication bus 2302, a user interface 2303, at least one external communication interface 2304 and a memory 2305. The communication bus 2302 is configured to realize connection and communication between these components. The user interface 2303 may include a display screen, and the external communication interface 2304 may include a standard wired interface and a wireless interface.

The memory 2305 is configured to store instructions and applications executable by the processor 2301, and may also cache data to be performed or processed by the processor 2301 and various modules in the electronic device (for example, image data, audio data, voice communication data, and video communication data), which may be implemented through flash memory or random access memory (RAM).

In another aspect, embodiments of the disclosure provide a computer-readable storage medium, on which a computer program is stored. When the computer program is executed by a processor, the steps in the task information determination methods provided in the above embodiments are implemented.

In another aspect, embodiments of the disclosure provide a computer program product, which includes a computer program, and when the computer program is executed by a processor, it implements the steps in the task information determination methods provided in the above embodiments.

It should be noted here that the description of the above storage medium and device embodiments is similar to the description of the above method embodiments, and has similar beneficial effects as the method embodiments. For technical details not disclosed in the storage medium and device embodiments of the disclosure, refer to the description of the method embodiments of the disclosure for understanding.

It should be noted that “one embodiment” or “an embodiment” mentioned throughout the specification means that specific features, structures or characteristics related to the embodiment are included in at least one embodiment of the disclosure. Therefore, “in one embodiment” or “in some embodiments” appearing throughout the specification may not necessarily refer to the same embodiment. In addition, these specific features, structures or characteristics may be combined in one or more embodiments in any suitable manner. It should be noted that in various embodiments of the disclosure, the values of the sequence number of the above-described processes do not mean the order of execution. The execution order of each process should be determined by its function and internal logic, and should not constitute any limitation on the implementation process of the embodiments of the disclosure. The sequence numbers of the embodiments of the disclosure are for description only and do not represent the advantages and disadvantages of the embodiments.

It should be noted that, in the disclosure, the terms “include”, “comprises” or any other variations thereof are intended to cover non-exclusive inclusion, so that a process, method, article or apparatus including a series of elements includes not only those elements, but also other elements not explicitly listed, or also includes elements inherent to such process, method, article or apparatus. In the absence of further restrictions, an element defined by the sentence “comprises a . . . ” does not exclude the existence of other identical elements in the process, method, article or apparatus including the element.

In the embodiments provided in the disclosure, it should be understood that the disclosed devices and methods may be implemented in other ways. The device embodiments described above are merely schematic. For example, the division of the units is merely a logical function division. There may be other division methods in actual implementation, such as multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separated, and the components displayed as units may or may not be physical units. These units may be located in one place or distributed on multiple network units. Some or all of the units may be selected according to actual needs to achieve the purpose of the present disclosure.

In addition, all functional units in the embodiments of the disclosure may be integrated into one processing unit, or each unit may be a separate unit, or two or more units may be integrated into one unit. The integrated units may be implemented in the form of hardware or in the form of hardware plus software functional units.

A person of ordinary skill in the art may understand that: all or part of the steps of implementing the above method embodiments may be completed by hardware related to program instructions, and the aforementioned program may be stored in a computer-readable storage medium. When the program is executed, it executes the steps of the above method embodiments. The storage medium includes various media that may store program codes, such as mobile storage devices, read-only memories (ROM), magnetic disks or optical disks.

Alternatively, if the integrated unit of the disclosure is implemented in the form of a software function module and sold or used as an independent product, it may also be stored in a computer-readable storage medium. Based on this understanding, the technical solution of the embodiments of the disclosure may be essentially or partly reflected in the form of a software product that contributes to the relevant technology. The computer software product is stored in a storage medium, including several instructions for a computer device (which may be a personal computer, server, or network device, etc.) to execute all or part of the methods described in each embodiment of the disclosure. The aforementioned storage medium includes: various media that may store program codes, such as mobile storage devices, ROMs, disks, or optical disks.

The foregoing description is merely some implementation methods of the disclosure, but the protection scope of the disclosure is not limited thereto. A person skilled in the art may easily think of changes or substitutions within the technical scope disclosed in the disclosure, which should fall within the protection scope of the disclosure. Therefore, the protection scope of the disclosure should be based on the protection scope of the claims.

What is claimed is:

1. A method for determining task information, comprising:
obtaining a first route, wherein the first route corresponds to a moving trajectory of an acquisition device during a process of acquiring a first set of images of a target space, wherein the first set of images is used to determine a target map corresponding to the target space;
determining a second route based on the first route, wherein the second route is at least partially identical to the first route; and
determining a target task of a target device in the target space according to the second route and task point information.

2. The method according to claim 1, wherein the target space includes a target object, and the target object is able to hinder the target device from moving in the target space.

3. The method according to claim 1, wherein determining the second route according to the first route comprises:
performing a clipping process on the first route to obtain a clipping result; and
determining the second route according to the clipping result.

4. The method according to claim 3, wherein performing the clipping process on the first route to obtain the clipping result comprises:
obtaining information corresponding to a target point, wherein the target point includes at least one of a task point or a waypoint, wherein the waypoint represents a point at which a motion state of the target device changes; and
performing the clipping process on the first route according to the information corresponding to the target point to obtain the clipping result.

5. The method according to claim 3, wherein performing the clipping process on the first route to obtain the clipping result comprises:
receiving a clipping instruction, wherein the clipping instruction includes clipping location information; and
performing the clipping process on the first route according to the clipping location information to obtain the clipping result.

6. The method according to claim 1, wherein determining the second route according to the first route comprises:
determining an intermediate result route according to the first route;
determining target direction information corresponding to the intermediate result route, wherein the target direction information matches the target task; and
determining the second route according to the intermediate result route and the target direction information.

7. The method according to claim 6, wherein determining the target direction information corresponding to the intermediate result route comprises:
obtaining information corresponding to multiple task points;
determining execution order information among the multiple task points according to the information corresponding to the multiple task points; and
determining the target direction information according to the execution order information and the intermediate result route.

8. The method according to claim 1, wherein determining the second route according to the first route comprises:
determining a target sub-route according to the first route, the target sub-route being a part of the first route; and
adjusting the target sub-route to a target straight-line route.

9. The method according to claim 1, wherein determining the second route according to the first route comprises:
determining information corresponding to a charging point, wherein the charging point is in the target space, and the charging point corresponds to a charging device for charging the target device; and
determining, from the first route, a starting point of the second route according to the information corresponding to the charging point.

10. An electronic device, including a memory and one or more processors, wherein the memory stores a computer program executable by the one or more processors, and when executing the computer program, the one or more processor are configured to perform:
obtaining a first route, wherein the first route corresponds to a moving trajectory of an acquisition device during a process of acquiring a first set of images of a target space, wherein the first set of images is used to determine a target map corresponding to the target space;
determining a second route based on the first route, wherein the second route is at least partially identical to the first route; and
determining a target task of a target device in the target space according to the second route and task point information.

11. The electronic device according to claim 10, wherein the target space includes a target object, and the target object is able to hinder the target device from moving in the target space.

12. The electronic device according to claim 10, wherein the one or more processors are further configured to perform:
performing a clipping process on the first route to obtain a clipping result; and
determining the second route according to the clipping result.

13. The electronic device according to claim 12, wherein the one or more processors are further configured to perform:
obtaining information corresponding to a target point, wherein the target point includes at least one of a task point or a waypoint, wherein the waypoint represents a point at which a motion state of the target device changes; and
performing the clipping process on the first route according to the information corresponding to the target point to obtain the clipping result.

14. The electronic device according to claim 12, wherein the one or more processors are further configured to perform:
receiving a clipping instruction, wherein the clipping instruction includes clipping location information; and
performing the clipping process on the first route according to the clipping location information to obtain the clipping result.

15. The electronic device according to claim 10, wherein the one or more processors are further configured to perform:
determining an intermediate result route according to the first route;
determining target direction information corresponding to the intermediate result route, wherein the target direction information matches the target task; and
determining the second route according to the intermediate result route and the target direction information.

16. The electronic device according to claim 10, wherein the one or more processors are further configured to perform:
obtaining information corresponding to multiple task points;
determining execution order information among the multiple task points according to the information corresponding to the multiple task points; and
determining the target direction information according to the execution order information and the intermediate result route.

17. The electronic device according to claim 10, wherein the one or more processors are further configured to perform:
determining a target sub-route according to the first route, the target sub-route being a part of the first route; and
adjusting the target sub-route to a target straight-line route.

18. The electronic device according to claim 10, wherein the one or more processors are further configured to perform:
determining information corresponding to a charging point, wherein the charging point is in the target space, and the charging point corresponds to a charging device for charging the target device; and
determining, from the first route, a starting point of the second route according to the information corresponding to the charging point.

19. A non-transitory computer-readable storage medium, storing a computer program that, when being executed, causes at least one processor to implement a task information determination method comprising:
obtaining a first route, wherein the first route corresponds to a moving trajectory of an acquisition device during a process of acquiring a first set of images of a target space, wherein the first set of images is used to determine a target map corresponding to the target space;
determining a second route based on the first route, wherein the second route is at least partially identical to the first route; and
determining a target task of a target device in the target space according to the second route and task point information.

20. The non-transitory computer-readable storage medium according to claim 19, wherein the target space includes a target object, and the target object is able to hinder the target device from moving in the target space.
